(19) United States
(12) Patent Application Publication
(10) Pub. No.: US 2016/0297044 A1
(43) Pub. Date: Oct. 13, 2016

(54) MACHINING PARAMETER CONTROL BASED ON ACOUSTIC MONITORING

(71) Applicant: Rolls-Royce Corporation, Indianapolis, IN (US)

(72) Inventors: Mike R. Dunkin, Carmel, IN (US); Clinton A. Hammes, Zionsville, IN (US)

(21) Appl. No.: 15/094,574

(22) Filed: Apr. 8, 2016

Related U.S. Application Data
(60) Provisional application No. 62/145,915, filed on Apr. 10, 2015.

(51) Int. Cl. B23Q 17/09; G05B 19/404

(52) U.S. Cl. CPC B23Q 17/0976; G05B 19/404; G05B 2219/37435

(57) ABSTRACT

A computing devices sends control signals to a machine tool to machine a component to form a feature in the component according to the control signals. The computing device monitors, while machining the feature into the component with the machine tool, acoustic signals produced by the machining of the component by the machine tool. During the machining of the feature into the component, the computing device modifies at least one machining parameter defined by the control signals based on the monitored acoustic signals. The computing device continues to send the modified control signals to the machine tool to machine the feature into the component according to the modified machining parameter.

This application claims the benefit of U.S. Provisional Application No. 62/145,915 filed Apr. 10, 2015, which is incorporated herein by reference in its entirety.

### TECHNICAL FIELD

The invention relates to automated control of a machine tool.

### BACKGROUND

Tool vibrations may occur during machining of components by use of program-controlled machine tools. The tool vibrations may affect the machining accuracy and the finish quality of the component and may also reduce the life of the tool. For this reason, a machining control program may include to machining parameters selected to limit vibrations during machining.

### SUMMARY

This disclosure is directed to techniques for automated control of a machine tool. In some examples, a controller for a machine tool may monitor acoustic signals during machining to evaluate the quality of a machined component. The controller may modify a machining parameter of the machining of the component based on the monitored acoustic signals. For example, the controlled may select a modified machining parameter expected to reduce vibrations such as chatter resulting from machining resonance. The disclosed techniques may be applied to the machining of thin-walled components, which may be associated with relatively unpredictable vibrations modes (e.g., machining resonances) during a machining process.

In one example, this disclosure is directed to a method comprising sending, by a computing device, control signals to a machine tool to machine a component to form a feature in the component according to the control signals, monitoring, by the computing device, while machining the feature into the component with the machine tool, acoustic signals produced by the machining of the component by the machine tool, during the machining of the feature into the component, modifying, by the computing device, at least one machining parameter defined by the control signals based on the monitored acoustic signals, and continuing to send, by the computing device, the modified control signals to the machine tool to machine the feature into the component according to the modified machining parameter

In another example, this disclosure is directed to a system comprising a machine tool, and a computing device. The computing device is configured to send control signals to the machine tool for causing the machine tool to machine a component to form a feature in the component, monitor, while the machine tool machines the feature into the component, acoustic signals of the machine tool used to machine the component, during the machining of the feature into the component, modify at least one machining parameter defined by the control signals based on the monitored acoustic signals, and continue to send the modified control signals to the machine tool to machine the feature into the component according to the modified machining parameter.

In a further example, this disclosure is directed to a non-transitory computer-readable data storage medium having instructions stored thereon that, when executed by one or more processors of a computing device, cause the computing device to send control signals to a machine tool for causing the machine tool to machine a component to form a feature in the component, monitor, while the machine tool machines the feature into the component, acoustic signals of the machine tool used to machine the component, during the machining of the feature into the component, modify at least one machining parameter defined by the control signals based on the monitored acoustic signals, and continue to send the modified control signals to the machine tool to machine the feature into the component according to the modified machining parameter.

The details of one or more examples of this disclosure are set forth in the accompanying drawings and the description below. Other features, objects, and advantages of this disclosure will be apparent from the description and drawings, and from the claims.

### BRIEF DESCRIPTION OF DRAWINGS

FIG. 1 illustrates a system including a machine tool and a computing device configured to modify a machining parameter while machining with the machine tool based on monitored acoustic signals of the machine tool.

FIG. 2 illustrates the frequency response of a thin-wall structure during a machining process.

FIG. 3 illustrates a stability diagram of the thin-wall structure of FIG. 2 during the machining process.

FIG. 4 illustrates the frequency response of the thin-wall structure at a later time during the machining process.

FIG. 5 illustrates a stability diagram of the thin-wall structure of FIG. 4 during the machining process.

FIGS. 6A-6C are conceptual diagrams of an example blade airfoil configured for use in a gas turbine engine, the airfoil including thin-wall features fabricated as disclosed herein.

FIG. 7 is a flowchart illustrating example techniques for modify a machining parameter while machining with the machine tool based on monitored acoustic signals of the machine tool.

### DETAILED DESCRIPTION

Vibrations during fabrication and resulting quality of machined features may vary even when a series of components is fabricated using the same equipment according to the same design and specifications resulting in variations in finish quality of machined surfaces among the series of components. For example, machining of thin-walled components may be associated with relatively unpredictable component vibration modes during a machining process. As described herein, machining parameters may be modified during machining of the feature based on monitoring acoustic signals from the machining of the feature by a machine tool.

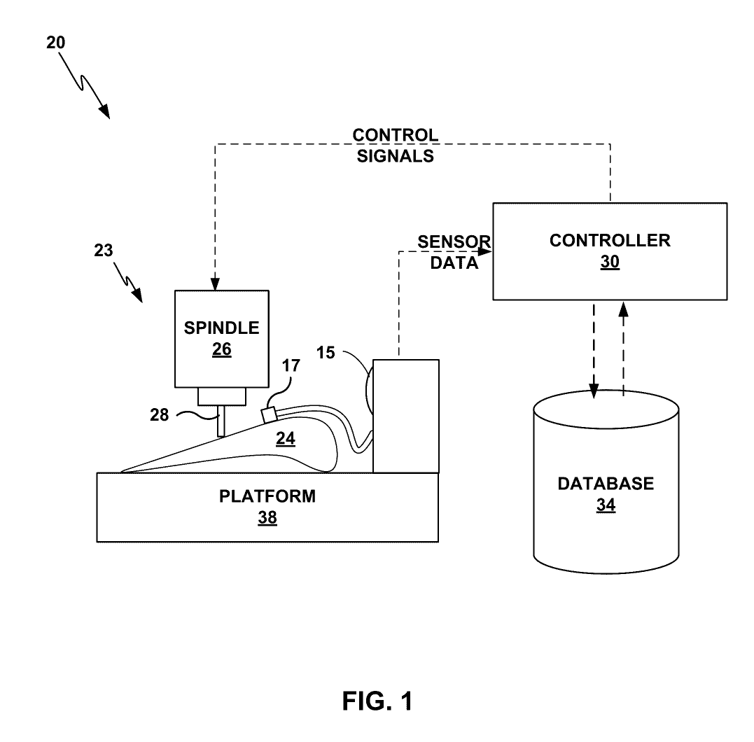

FIG. 1 illustrates system 20, which includes machine tool 23 and machine tool controller 30. Controller 30 is configured to send control signals to machine tool 23 for causing machine tool 23 to machine component 24 to form a feature in component 24. Machine tool 23 is configured to perform a machining operation on workpiece 24 with spindle 26 and element 28. In one example, machine tool 23 may represent a computer numerical control (CNC) machine capable of performing routing, turning, drilling, milling, grinding, sanding and/or other machining operations. In various examples, machine tool 23 may include any of a variety of machining equipment, such as, but not limited to, a mill, a drill, a blisk machine, a high speed disk manufacturing device, a grinder, a sander, a lathe, a thin-wall structure manufacturing device, and a blade manufacturing device.

Workpiece 24 is mounted to platform 38 in a manner that facilitates precise machining of workpiece 24 by machine tool 23. While the techniques disclosed herein may apply to workpieces of any materials, workpiece 24 may be metal, such as a thin wall metal.

Controller 30 represents a computing device configured to operate machine tool 23. In some examples, controller may be configured to adaptively machine workpiece 24 based on real-time or near real-time feedback of signals associated with the operation of machine tool 23, such as one or more of acoustic signals of spindle 26, vibration signals of component 24 via vibration sensor 17, element 28 vibration, and/or feed and/or rotational forces of machine tool 23. Controller 30 may further be configured to prevent harmonic excitation of element 28 and component 24 based on the signals, such as monitored acoustic signals of spindle 26 of machine tool 23 or generated by interaction of machine tool 23 and workpiece 24.

Control signals from controller 30 for causing machine tool 23 to machine workpiece or component 24 may be based on a predetermined design of the feature and the monitored signals such as monitored acoustic signals. Controller 30 is further configured to, during the machining of the feature into component 24, modify at least one machining parameter defined by the control signals based on the monitored acoustic signals. For example, controller 30 may operate to adjust the feed rate of spindle 26, rotational speed of spindle 26, machining depth of spindle 26, feed force of spindle 26, and/or rotational force of spindle 26 based on the monitored acoustic signals to prevent harmonic excitation (e.g., resonance) of element 28 and component 24.

In one particular example, controller 30 may select the at least one machining parameter to mitigate machining resonance or machining resonance induced chatter during the machining of component 24 by machine toot 23. For example, controller 30 may assess monitored acoustic signals of spindle 26 by evaluating overall maximum acoustic signals, variation between maximum and minimum acoustic signals, along with frequency of acoustic signals variation. In this manner, controller 30 may operate to automatically mitigate harmonic excitation (e.g., machining resonance) of element 28 and component 24 based on monitored acoustic signals of machine tool 23, and potentially other machining variables, during the machining of features in component 24. Controller 30 is further configured to continue to send the modified control signals to machine tool 23 to machine the feature into component 24 according to the modified machining parameters.

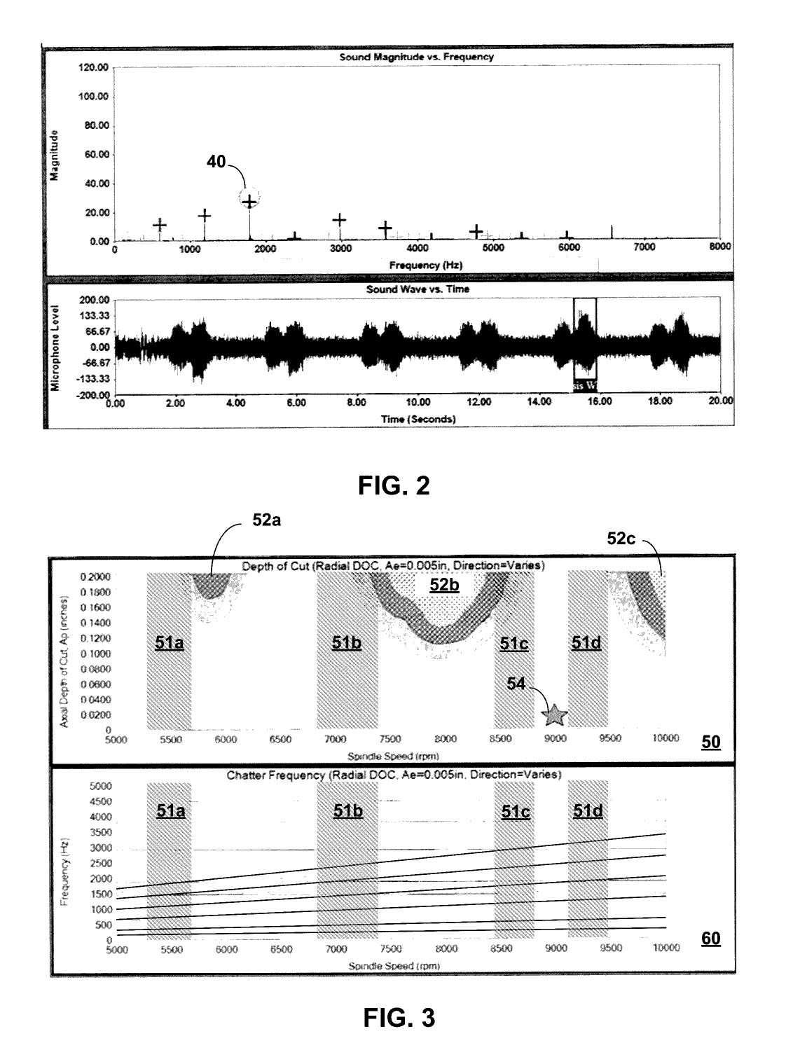

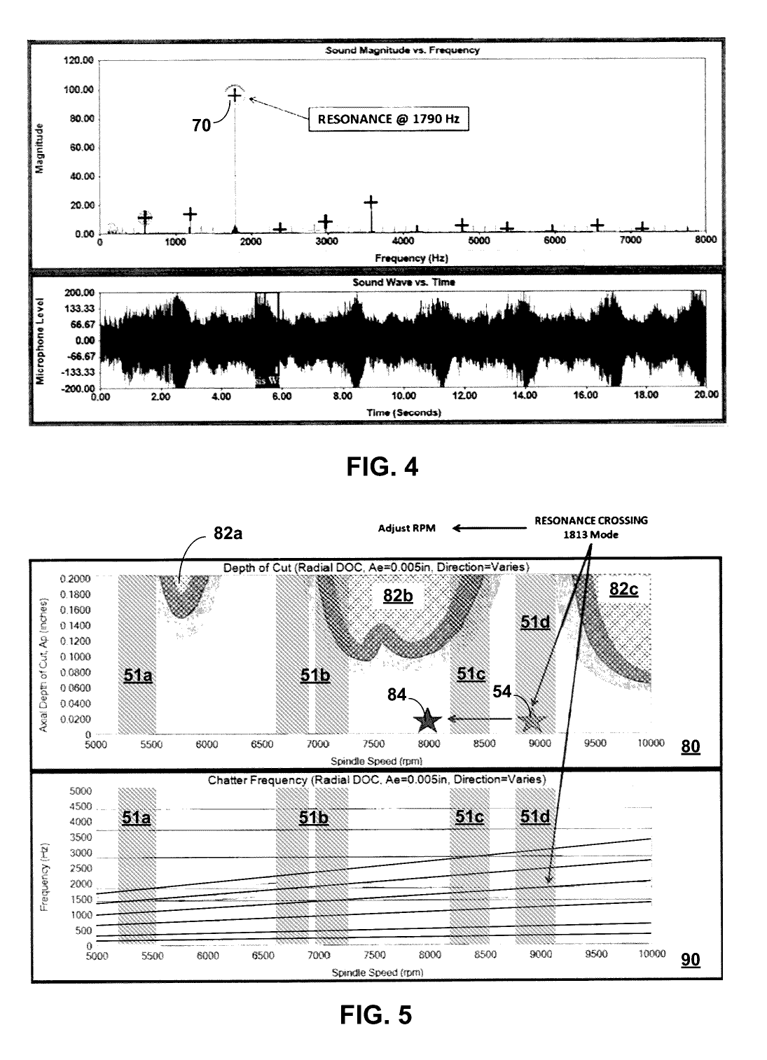

Acoustic sensor 15 may be a microphone, such as a directional microphone configured to detect on or more of audible signals, subsonic signals or ultrasonic signals. While acoustic sensor 15 is depicted as being located on platform 38, acoustic sensor 115 may be positioned in other places, such as on spindle 26 or a mechanical holding arm (not shown) for spindle 26. In the same or different examples, multiple acoustic sensors may be used to monitor an acoustic signal. For example, multiple signal inputs, such as microphones placed in different locations and timing signals from the machining, may be used to effectively filter background noise generated from the machining process. In some examples, noise filtering may include filtering ambient noises and noises associated with the operation of machine tool 23 when element 28 is not contacting component 24. In the same or different examples, noise filtering may include actively sensing for known or predicted resonance frequencies of component 24 and/or element 28, such as harmonic frequencies as discussed in further detail with respect to FIG. 2 and FIG. 4.

System 20 is also shown with an optional vibration sensor 17. In some examples, controller 30 may monitor, while machining the feature into component 24 with machine tool 23, vibrations produced by the machining of component 24 by machine tool 23 via vibration signals. Controller 20 may modify at least one machining parameter defined by the control signals based on the monitored vibration signals, either in conjunction with or instead of monitored acoustic signals. For example, controller 30 may operate to adjust the teed rate of spindle 26, rotational speed of spindle 26, machining depth of spindle 26, feed force of spindle 26 and/or rotational force of spindle 26 based on the monitored vibration signals to prevent harmonic excitation of element 28 and component 24. In one particular example, controller 30 may select the at least one machining parameter to mitigate machining resonance or machining resonance induced chatter during the machining of component 24 by machine tool 23. Controller 30 is further configured to continue to send the modified control signals to machine tool 23 to machine the feature into component 24 according to the modified machining parameters.

In some particular examples, controller 30 may include multiple computing devices that combine to provide the functionality of controller 30 as described herein, For example, controller 30 may comprise a CNC controller that issues instructions to spindle 26 and positioning actuators of machine tool 23 as well as a separate computing device that monitors acoustic signals from machine tool 23 and actively adjusts the feed rate, depth and/or rotational speed of spindle 26 based on the monitored signals.

In some examples, such a computing device may represent a general purpose computer running software, Software suitable for actively controlling machining parameters includes Tool Monitor Adaptive Control (TMAC) software from Caron Engineering of Wells, Me., United States. In addition, software suitable for actively monitoring acoustic signals to detect machining resonance or machining resonance induced chatter includes Harmonizer software from BlueSwarf LLC of State College, Pa., United States.

In a specific example where component 24 is a thin-walled component, machine component 24 to form a feature in component 24 may include reducing a wall thickness of component 24. For example, component 24 may be a thin-walled component providing thicknesses of less than about 0.01 inches. In one particular example, component 24 may be a blade airfoil. As represented by FIGS. 2-5, machining of a thin walled component may alter the resonance profile of the component.

FIGS. 2-5 illustrate acoustic frequency responses and stability diagrams for a thin-walled component. In particular, FIG. 2 illustrates the acoustic frequency response of a thin-wall structure during a machining process, and FIG. 3 illustrates a stability diagram of the thin-wall structure of FIG. 2 during the machining process. The thin-wall structure utilized to obtain the data shown in FIGS. 2 and 3 had a wall thickness of about 0.0030 inches. In contrast, FIGS. 4 and 5 represent the frequency response and stability diagram, respectively, for the same thin-wall structure represented by FIGS. 2 and 3, except that the wall thickness has been reduced by milling to about 0.0020 inches.

As shown in FIG. 2, the acoustic frequency response of a thin-wall structure during a machining process includes a number of sound frequency magnitude peaks, the highest of which is indicated as peak 40, occurs around 1800 hertz. The relative magnitude at peak 40 is approximately 25 units for the thin-wall structure represented by FIG. 2, which has a wall thickness of about 0.0030 inches.

As mentioned previously, FIG. 3 illustrates a stability diagram of the thin-wall structure of FIG. 2 during the same machining process. More specifically, the top plot 50 of FIG. 3 illustrates chatter regions 52a-52c within the tooth passing frequency versus the axial depth of cut. The lower plot 60 illustrates mode shape frequencies at various tooth passing frequencies. To avoid machining resonance or machining resonance induced chatter, the tooth passing frequency, determined based on the rotational speed of the tool and the number of teeth on the tool element, should avoid the harmonic frequencies 51a-51d of the component being machined.

FIG. 3 further illustrates point 54, which represents machining parameters of depth and the tooth passing frequency selected between chatter region 52b and chatter regions 52c, and also between the first harmonic frequency 51c and the second harmonic frequency 51d of the thin-walled structure to mitigate machining resonance or machining resonance induced chatter caused by the machining of the example thin-wall structure with a wall thickness of about 0.0030 inches. Machining according to point 54 produced the acoustic frequency magnitudes of FIG. 2 which are relatively minimal as compared to the acoustic frequency magnitudes of FIG. 4.

FIG. 4 illustrates the change in acoustic frequency magnitudes from the machining process when the component was milled from a wall thickness of about 0.0030 inches to wall thickness of about 0.0020 inches according to the machining parameters of depth and tooth passing frequency represented by point 54. As represented by peak 70 of FIG. 4, the magnitude of the second harmonic frequency 51d (1790 Hertz) was significantly increased to a magnitude of about 95 by the milling of the example thin walled component from a wall thickness of about 0.0030 inches to wall thickness of about 0.0020 inches. The relative magnitude at peak 70 is approximately 75 units for the thin-wall structure represented by FIG. 4. The increase in magnitude of the second harmonic frequency 51d was the result of the harmonic frequencies of the component being machined, as represented by plot 90 of FIG. 5. Likewise as material is removed chatter regions 82a-82c in plot 80 have shifted shift down and to the left as compared to chatter regions 52a-52c.

In order to mitigate the machining resonance or machining resonance induced chatter represented by FIGS. 4 and 5, spindle rate may be reduced from point 54 to point 84 as shown in plot 80. Reducing machining resonance or machining resonance induced chatter results in a reduction in the acoustic frequency magnitudes shown in FIG. 4, By actively monitoring the acoustic signals represented by FIGS. 2 and 4 during the machining of the thin-wall structure, a computing device controlling the machining may adjust reduce the spindle speed in response to changes in acoustic frequency magnitudes in order to remain between the harmonic frequencies of the component being machined, and also remain distant from chatter regions, even as the harmonic frequencies of the component being machined and the chatter regions change as a result of the machining in a closed-loop control of machining parameters.

Actively mitigating machining resonance or machining resonance induced chatter may provide one or more advantages including, but not limited to, increased tooling life, improved surface finish and increased productivity resulting from active selection of machining parameters according to acoustic signals produced by the machining.

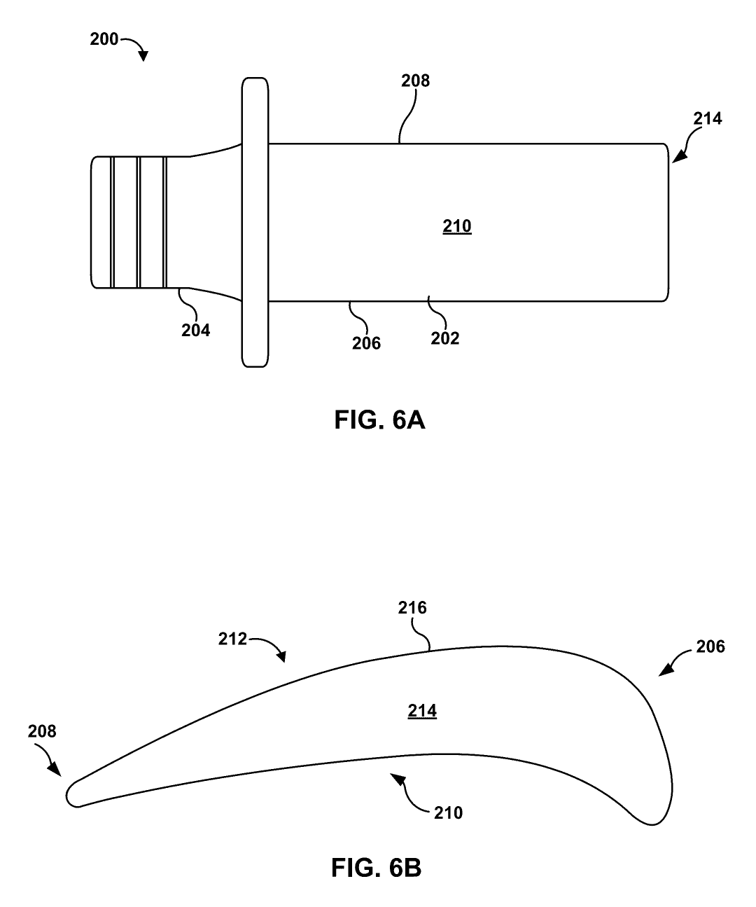

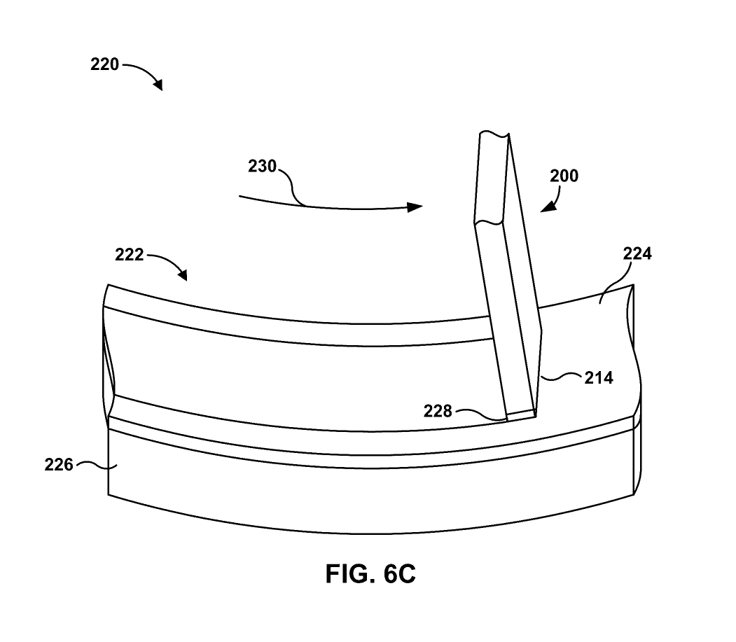

FIGS. 6A-6C illustrate different views of an example blade 200, which represents one example of component 24. Blade 200 may also incorporate thin-wall structures as discussed with respect to FIGS. 2-5. Blade 200 generally includes airfoil 202 attached to stalk 204. Airfoil 202 includes a leading edge 206, a trailing edge 208, a pressure sidewall 210, and a suction sidewall 212. Pressure sidewall 210 is connected to suction sidewall 212 at leading edge 206 and trailing edge 208. Further, blade 200 defines blade tip 214, which is a surface substantially orthogonal to leading edge 206. Blade tip 214 is defined by an edge 216 that extends about the perimeter of the surface of blade tip 214, and separates the surface of blade tip 214 from the adjacent surface of airfoil 202. Leading edge 206, trailing edge 208, pressure sidewall 210, and suction side wall 212 generally extend from stalk 204 to edge 216.

In general, blade 200 is a component of a mechanical system including, e.g., a gas turbine engine, In different examples, blade 200 may be a compressor blade that imparts kinetic energy into a fluid or a turbine blade that extracts kinetic energy from a moving fluid. FIG. 6C is a conceptual diagram of an example gas turbine engine 220 with blade 200, Gas turbine engine 220 includes blade track or blade shroud 222, which is defined into a surface 224 of a turbine substrate 226. Blade 200 is shown with a tip coating 228 deposited on blade tip 214. Tip coating 228 may combine with thin film cooling to protect blade 200 from extreme temperatures during operation of its mechanical system. Although a single blade 200 is shown in gas turbine engine 220 for ease of description, in actual operation, gas turbine engine 220 may include a plurality of blades.

During operation of gas turbine engine 220, blade 200 rotates relative to blade track 222 in a direction indicated by arrow 230. In general, the power and efficiency of gas turbine engine 220 can be increased by reducing the gap blade track 222 and blade 200, e.g., to reduce or eliminate gas leakage around blade 200. Thus, gas turbine engine 220, in various examples, is configured to allow blade 200 to abrade into surface 224 of turbine substrate 226, thereby defining blade track 222, which creates a seal between blade track 222 and blade 200. The abrading action may create high thermal and shear stress forces at blade tip 214. In addition, occasional movement of blade tip 214 relative to turbine substrate 226 during the operation of gas turbine engine 222 may cause blade tip 214 to impinge on turbine substrate 226, creating high shear forces at blade tip 214.

To protect against the various forces acting on blade 200 and, in particular, blade tip 214, one or more protective layers may be provided on blade 200 and/or blade tip 214. For example, a tip coating 228, may be provided on blade tip 214 to improve different properties of an underlying blade surface including, e.g., wear, corrosion, hardness, and/or temperature resistance properties of an underlying blade surface. Additionally or alternatively, a protective coating may be applied to an entire airfoil 202, including blade tip 214, to improve different properties of an underlying blade surface. In some examples, airfoil 202 may receive a coating that reduces or substantially eliminates the effects of oxidation or corrosion on airfoil 202. Regardless of the specific number or specific type of coatings applied to blade 200, in some examples, blade 200 may benefit from the features and arrays of features, such as an array of thin film cooling holes, described in the disclosure.

An airfoil, such as blade 200, may include additional machined features, which may be machined in conjunction with the fabrication of thin film cooling holes to reduce the cycle time required to for the blade airfoil. For example, machining to produce a blade airfoil, such as blade 200, may include gating removal and/or throat machining at the leading edge of the blade airfoil. As another example, machining to produce a blade airfoil may include hole drilling along the trailing edge of the blade airfoil. As further examples, machining to produce a blade airfoil may also include slash face along fore and aft faces and/or tip cap finishing. Each of these machining processes may be implemented in combination with techniques to mitigate machining resonance or machining resonance induced chatter. In addition, more than one feature may potentially be machined simultaneously on blade airfoil to further reduce cycle time.

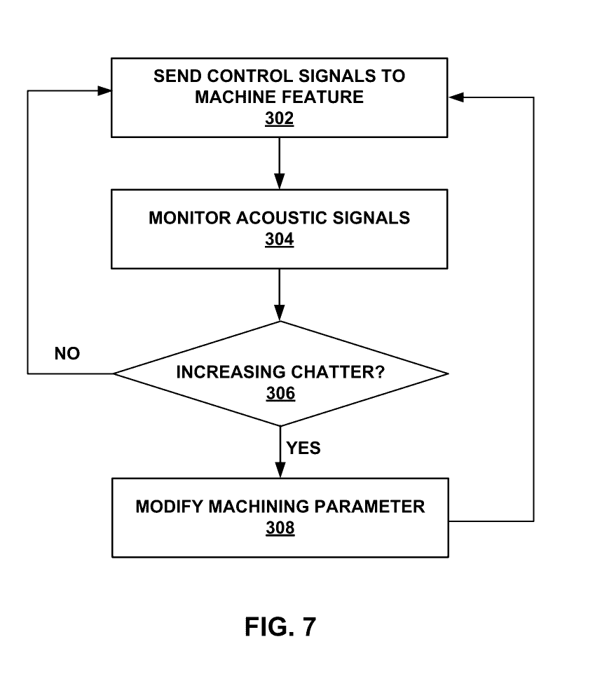

FIG. 7 is a flowchart illustrating example techniques for modify a machining parameter while machining with the machine tool based on monitored acoustic signals of the machine tool. For clarity, the techniques of FIG. 7 are described with respect to system 20 of FIG. 1, including controller 30.

Controller 30 sends control signals machine tool 23 to machine component 24 to form a feature in component 24 according to the control signals (302). While machining the feature into component 24 with machine tool 23, controller 30 monitors acoustic signals produced by the machining of the component 24 by machine tool 23 via acoustic sensor 15 (304). For example, controller 34 may continuously evaluate the acoustic signals to determine whether there is increasing machining resonance or machining resonance induced chatter (306). Controller 30 modifies at least one machining parameter defined b the control signals based on the monitored acoustic signals (308). For example, controller 30 may operate to adjust the feed rate of spindle 26, rotational speed of spindle 26, machining depth of spindle 26, feed force of spindle 26 and/or rotational force of spindle 26 based on the monitored vibration signals to prevent harmonic excitation of element 28 and component 24. Controller 30 continues to send the modified control signals to machine tool 23 to machine the feature into component 24 according to the modified machining parameter (302).

In some examples, controller 30 may further monitor vibrations signals produced by the machining of the component 24 by machine tool 23 via vibration sensor 17. For example, controller 34 may continuously evaluate the vibrations and the acoustic signals to determine whether there is increasing machining resonance or machining resonance induced chatter. In such an example, modification of the machining parameter may be further based on the monitored vibrations.

In some examples, controller 30 may store an indication of the monitored acoustic signals, the monitored vibrations, and/or the modified machining parameters on a non-transitory computer-readable data storage medium of controller 30. Such information may he later retrieved to evaluate a quality of component 24, and/or the operation of machine tool 23 and controller 30.

The techniques described in this disclosure may be implemented, at least in part, in hardware, software, firmware, or any combination thereof For example, various aspects of the described techniques, including controller 30, may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer system-readable medium, such as a computer system-readable storage medium, containing instructions. Instructions embedded or encoded in a computer system-readable medium, including a computer system-readable storage medium, may cause one or more programmable processors, or other processors, to implement one or more of the techniques described herein, such as when instructions included or encoded in the computer system-readable medium are executed by the one or more processors. Computer system readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer system readable media. In some examples, an article of manufacture may comprise one or more computer system-readable storage media.

Various examples of this disclosure have been described. These and other examples are within the scope of the following claims.

What is claimed is:

1. A method comprising:
sending, by a computing device, control signals to a machine tool to machine a component to form a feature in the component according to the control signals;
monitoring, by the computing device, while machining the feature into the component with the machine tool, acoustic signals produced by the machining of the component by the machine tool;
during the machining of the feature into the component, modifying, by the computing device, at least one machining parameter defined by the control signals based on the monitored acoustic signals; and
sending, by the computing device, the modified control signals to the machine tool to machine the feature into the component according to the modified machining parameter.

2. The method of claim 1, further comprising selecting, by the computing device, the at least one machining parameter to mitigate machining resonance or machining resonance induced chatter during the machining of the component by the machine tool.

3. The method of claim 1, wherein the control signals are based on a predetermined design of the feature and the monitored acoustic signals.

4. The method of claim 1, further comprising:
monitoring, by the computing device, while machining the feature into the component with the machine tool, vibrations produced by the machining of the component by the machine tool,
wherein modifying, by the computing device, at least one machining parameter defined by the control signals is further based on the monitored vibrations.

5. The method of claim 1, wherein the modified parameters are selected to avoid harmonic frequencies of the component as partially machined.

6. The method of claim 1, wherein machining the component with the machine tool includes at least one of:
milling;
drilling;
blisk machining;
high speed disk manufacturing;
grinding;
sanding;
turning;
thin-wall structure manufacturing; and
blade manufacturing.

7. The method of claim 1, wherein the at least one parameter includes one or more of:
machining rotational velocity;
machining feed rate;
machining rotational force;
machining feed force; and
machining depth.

8. The method of claim 1, wherein the component is a thin-walled component defining thicknesses of less than about 0.01 inches.

9. The method of claim 1, wherein the component is a blade airfoil.

10. A system comprising:
a machine tool: and
a computing device, wherein the computing device is configured to:
send control signals to the machine tool for causing the machine tool to machine a component to form a feature in the component;
monitor, while the machine tool machines the feature into the component, acoustic signals of the machine tool used to machine the component;
during the machining of the feature into the component, modify at least one machining parameter defined by the control signals based on the monitored acoustic signals; and
send the modified control signals to the machine tool to machine the feature into the component according to the modified machining parameter.

11. The system of claim 10, wherein the computing device is further configured to select the at least one machining parameter to mitigate machining resonance or machining resonance induced chatter during the machining of the component by the machine tool.

12. The system of claim 10, wherein the control signals are based on a predetermined design of the feature and the monitored acoustic signals.

13. The system of claim 10, wherein the computing device is further configured to:
monitor, while machining the feature into the component with the machine tool, vibrations produced by the machining of the component by the machine tool,
wherein modifying, by the computing device, at least one machining parameter defined by the control signals is further based on the monitored vibrations.

14. The system of claim 10, wherein the modified parameters are selected harmonic frequencies of the component as partially machined.

15. The system of claim 10, wherein the machine tool includes at least one of:
mill;
drill;
blisk machine;
high speed disk manufacturing device;
grinder;
sander;
lathe;
thin-wall structure manufacturing device; and
blade manufacturing device.

16. The system of claim 10, wherein the at least one parameter includes one or more of:
machining rotational velocity;
machining feed rate;
machining rotational force;
machining teed force; and
machining depth.

17. The system of claim 10, further comprising the component, wherein the component is a thin-walled component providing thicknesses of less than about 0.01 inches.

18. The system of claim 10, further comprising an acoustic sensor, wherein the computing device monitors the acoustic signals via an acoustic sensor.

19. The system of claim 10, further comprising the component, wherein the component is a blade airfoil.

20. A non-transitory computer-readable data storage medium having instructions stored thereon that, when executed by one or more processors of a computing device, cause the computing device to:
send control signals to a machine tool for causing the machine tool to machine a component to form a feature in the component;
monitor, while the machine tool machines the feature in the component, acoustic signals of the machine tool used to machine the component;
during the machining of the feature into the component, modify at least one machining parameter defined by the control signals based on the monitored acoustic signals; and
send the modified control signals to the machine tool to machine the feature into the component according to the modified machining parameter.
